(19) United States
(12) Patent Application Publication
(10) Pub. No.: US 2014/0285153 A1
(43) Pub. Date: Sep. 25, 2014

(54) METHOD FOR OPERATING MOLTEN SALT BATTERY

(71) Applicants: SUMITOMO ELECTRIC INDUSTRIES, LTD, Osaka-shi, Osaka (JP); Kyoto University, Kyoto-shi, Kyoto (JP)

(72) Inventors: Atsushi Fukunaga, Osaka-shi (JP); Shinji Inazawa, Osaka-shi (JP); Koji Nitta, Osaka-shi (JP); Shoichiro Sakai, Osaka-shi (JP); Koma Numata, Osaka-shi (JP); Toshiyuki Nohira, Kyoto-shi (JP); Rika Hagiwara, Kyoto-shi (JP); Takayuki Yamamoto, Kyoto-shi (JP)

(73) Assignee: SUMITOMO ELECTRIC INDUSTRIES, LTD., Osaka-shi, Osaka (JP)

(21) Appl. No.: 14/352,673

(22) PCT Filed: Sep. 28, 2012
(86) PCT No.: PCT/JP2012/075045

§ 371 Date: Apr. 17, 2014

(30) Foreign Application Priority Data
Oct. 17, 2011 (JP) 2011-228111

(51) Int. Cl. H02J 7/00; H01M 10/36

(52) U.S. Cl. CPC H02J 7/00; H01M 10/36
USPC 320/127; 429/103

(57) ABSTRACT

Provided is a method for operating a molten salt battery having a sodium compound (NaCrO₂) in a positive electrode and tin (Sn) in a negative electrode with a molten salt as an electrolytic solution. Although the operating temperature range of the molten salt battery is originally from 57° C. to 190° C., the molten salt battery is operated with an internal temperature thereof (temperature of electrodes and molten salt) set at from 98° C. to 190° C. to cause sodium to turn to a liquid phase. The sodium penetrates into a Sn—Na alloy micronized in the negative electrode, so that separation of the Sn—Na alloy is suppressed.

### TECHNICAL FIELD

The present invention relates to a method for operating a molten salt battery.

### BACKGROUND ART

Recently, as secondary batteries having, in addition to a high energy density, a potent advantage of incombustibility, molten salt batteries having a molten salt with a low melting point (57° C.) as an electrolytic solution have been developed and receiving attention (see Non-Patent Literature 1). The operating temperature range of these molten salt batteries is from 57° C. to 190° C., and thus the temperature range on the high temperature side is wider as compared to the operating temperature range (from −20° C. to 80° C.) of lithium ion batteries. Therefore, the molten salt battery has the advantage that a heat exhaustion space and equipment for fire prevention or the like are not required, and even when individual unit cells are densely integrated to form an assembled battery, the battery is relatively compact as a whole. Such molten salt batteries are expected to be used for, for example, electric power storage in small and medium scale electric power networks and households etc.

### CITATION LIST

### Non-Patent Literature

Non-Patent Literature 1: “SEI WORLD”, March 2011 (VOL. 402), Sumitomo Electric Industries, Ltd.

### SUMMARY OF INVENTION

### Technical Problem

Recently, however, it has been found that a molten salt battery using a sodium compound for a positive electrode and tin for a negative electrode may have a reduced cycle life. The direct cause thereof is considered to be that a Sn—Na alloy formed on a negative electrode is micronized through expansion/contraction associated with a change in composition, and separates from a current collector.

In view of the problem described above, an object of the present invention is to improve the cycle life by suppressing separation of a tin (Sn)-sodium (Na) alloy in a negative electrode of a molten salt battery.

### Solution to Problem

The present invention provides a method for operating a molten salt battery having a sodium compound in a positive electrode and Sn in a negative electrode with a molten salt as an electrolytic solution, wherein the molten salt battery is operated with an internal temperature thereof set at from 98° C. to 190° C.

According to the method for operating a molten salt battery as described above, the molten salt battery is operated with the operating temperature limited to from 98° C. to 190° C. out of the range of from 57° C. to 190° C. which is the operating temperature range of the molten salt battery. Na has a melting point of 98° C., and therefore turns to a liquid phase to suppress or correct micronization of a Sn—Na alloy. In this way, separation of the Sn—Na alloy in the negative electrode of the molten salt battery can be suppressed to improve the cycle life.

The above-described operation method is a method for operating a molten salt battery, wherein where for example, current capacities of the positive electrode and the negative electrode are a positive electrode capacity and a negative electrode capacity, respectively, a value obtained by dividing the positive electrode capacity by the negative electrode capacity is within a range of from 1.0 to 1.8. At least under this precondition, improvement of the cycle life is achieved by the temperature limitation described above.

Further, the method for operating a molten salt battery according to the present invention is also an operation method, wherein a content of Na in the negative electrode at completion of charge is 3.75 times or more a content of Sn contained in the negative electrode in terms of atomic ratio. In this way, the cycle life is further improved under the above-described operating temperature and positive electrode/negative electrode capacity ratio conditions.

### Advantageous Effect of Invention

According to the present invention, the cycle life of a molten salt battery can be improved.

### BRIEF DESCRIPTION OF DRAWINGS

FIG. 1 is a graph illustrating charge-discharge characteristics at 121st to 123rd cycles for a cell of a molten salt battery;

FIG. 2 is a drawing illustrating an example of a configuration of a coin-type molten salt battery; and

FIG. 3 is a graph illustrating charge-discharge characteristics after at least 120 cycles.

### DESCRIPTION OF EMBODIMENTS

First, charge-discharge characteristics were examined for a test cell of Na/NaFSA-KFSA/Sn using a Na metal on the negative electrode side and Sn on the positive electrode side as one form of a molten salt battery. A molten salt of an electrolytic solution is a mixture of NaFSA (sodium bisfluorosulfonylamide) and KFSA (potassium bisfluorosulfonylamide). The operating temperature range of the molten salt battery is 57° C. to 190° C. In an actual molten salt battery, a sodium compound is used on the positive electrode side, and Sn is used on the negative electrode side.

The test cell has a configuration in which a Na metal is used for the negative electrode and Sn is used for the positive electrode for the purpose of examining charge-discharge characteristics of Sn with the Na metal as a counter electrode.

In the cell, a Na metal foil was used for the Na metal on the negative electrode side, the Na metal foil having a diameter of 18 mm and a thickness of 0.5 mm.

Sn on the positive electrode side was prepared in accordance with the following method.

First, as a current collector, a current collector made of an Al foil with a thickness of 20 μm and a diameter of 15 mm was used, and a soft etching treatment was first performed to remove an oxide film of the Al current collector with an alkaline etching treatment solution as a pretreatment of the Al current collector.

Next, a desmutting treatment (removal of smut (dissolution residues)) was performed using nitric acid.

After washing with water, the surface of the current collector, from which the oxide film had been removed, was subjected to a zincate treatment (zinc substitution plating) using a zincate treatment solution to form a Zn film having a thickness of 100 nm. Here, a Zn film peeling treatment may be performed once, followed by performing a zincate treatment again. In this case, a denser thin Zn film can be formed, so that adhesion to the current collector can be improved to suppress elution of Zn.

Next, the current collector provided with a Zn film was immersed in a plating bath containing a plating solution to perform Sn plating, thereby forming a Sn layer having a thickness of 10 μm.

Here, as a method for plating of Sn, plating can be performed by electroplating in which Sn is electrochemically deposited on a current collector made of Al or electroless plating in which Sn is chemically reductively-deposited.

A nonwoven fabric made of glass was used for a separator, and a positive electrode, a negative electrode and an electrolytic solution were incorporated to prepare a coin-type cell.

For the cell, 100 cycles of charge-discharge were performed between a lower limit cutoff voltage of 0.200 V and an upper limit cutoff voltage of 1.200 V with the internal temperature (temperature of positive and negative electrodes and molten salt) set at 90° C. (363 K). Since the voltage is a voltage based on a Na metal, the voltage of the cell is decreased by charge, and conversely the voltage of the cell is increased by discharge.

Next, 20 cycles of charge-discharge were subsequently performed with the drive voltage range expanded by setting the lower limit cutoff voltage at 0.005 V and the upper limit cutoff voltage at 1.200 V. As a result, it was found that there was almost no capacity (about 10 mAhg⁻¹) (g: mass of Sn used for the positive electrode of the cell). That is, as a result of performing 120 cycles of charge-discharge, there is almost no capacity.

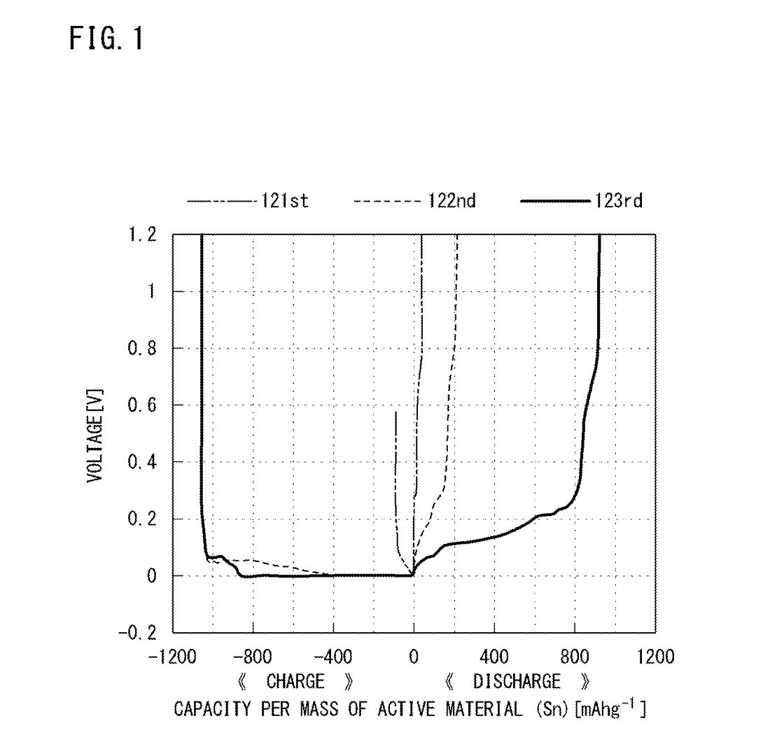

Here, the internal temperature is elevated from 90° C. to 105° C., and 121st and subsequent cycles of charge-discharge are performed. Charge is performed until attainment of 125% of the theoretical capacity (1059 mAhg⁻¹) (g: mass of Sn used for the positive electrode of the cell), and discharge is performed until attainment of 1.2 V. FIG. 1 is a graph illustrating charge-discharge characteristics at 121st to 123rd cycles.

Here, the theoretical capacity is a capacity at a maximum Na content (composition of Na₁₅Sn₄) where no Na metal but only a Na—Sn alloy phase exists.

In FIG. 1, the charge-discharge characteristics at the 121st cycle (two-dot chain line) are such that the cell gains almost no electric capacity even when charged, and is instantly discharged during discharge.

However, at the 122nd cycle (dashed line), charge characteristics are drastically improved, and the electric capacity is gained up to 125% of the theoretical capacity. On the other hand, discharge characteristics are found to be slightly improved, but is not good yet.

At the 123rd cycle (solid line), a surprising result was obtained in which not only charge characteristics but also discharge characteristics are drastically improved, so that a sufficient capacity is restored in both charge and discharge. A stagnancy around −10 mV, slightly below 0 V, during the 123rd charge is thought to be associated with a region where a solid Sn₄Na₁₅ alloy phase and a liquid phase of Na coexist.

Analysis of these results leads to the following findings.

As a reaction at the positive electrode during charge, Na in the negative electrode penetrates into Sn in the positive electrode, and a Sn—Na alloy is formed through Sn+Na⁺+e⁻. The ultimate of alloy composition is Sn₄Na₁₅. At this time, the positive electrode is expanded. At the time of discharge, Na leaves the positive electrode and returns to the negative electrode, so that the positive electrode is contracted. This expansion/contraction is responsible for the above-described micronization, but since the temperature is elevated, Na having a melting point of 98° C. turns to a liquid phase, and liquid Na penetrates into gaps of micronized Sn₄Na₁₅ so as to fill the gaps. Na penetrated in this way acts like a so-called glue to correct the state of micronization of Sn₄Na₁₅ and prevent Sn₄Na₁₅ from separating from the positive electrode.

The reason why the voltage of the cell is slantly increased to around from 0 to 0.3 V after the start of 123rd discharge in FIG. 1 is considered to be that Na penetrated into the gaps does not leave first, but Na leaves the alloy, i.e. Sn₄Na₁₅ first.

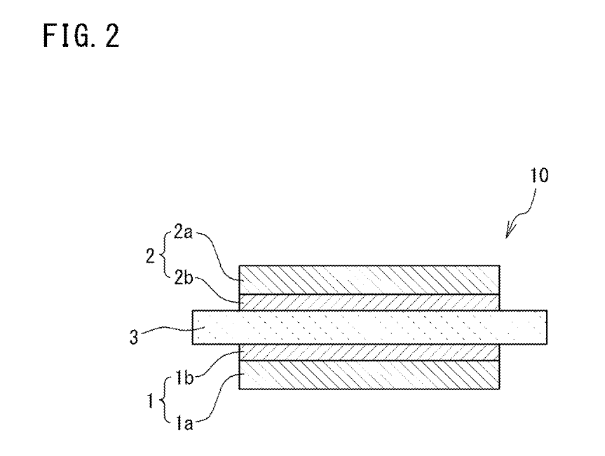

FIG. 2 is a drawing illustrating an example of a basic configuration of a coin-type molten salt battery (original molten salt battery different from the above-described cell) 10. A positive electrode 1 includes a current collector of positive electrode la and a positive electrode active material 1b. The current collector of positive electrode 1a is an aluminum foil. The positive electrode active material 1b is a sodium compound, for example NaCrO₂. The amount per unit area of the positive electrode active material 1b is 15 mg/cm² and the positive electrode capacity (per geometric area of electrode) is 1.125 mAh/cm².

Sodium chromite (NaCrO₂) was used as the positive electrode active material. Acetylene black was used as a conduction aid.

The content of the conduction aid in the positive electrode is preferably from 5% by mass to 20% by mass inclusive, and was 8% by mass in this example.

Polytetrafluoroethylene (PTFE) or polyvinylidene fluoride (PVdF) was used as a binder.

The content of the binder in the positive electrode is preferably from 1% by mass to 10% by mass inclusive, and was 5% by mass in this example.

An organic solvent (N-methylpyrrolidone) was added to a mixture of NaCrO₂, the conduction aid and the binder, and the mixture was kneaded into a paste form, and applied onto an aluminum foil having a thickness of 20 μm. Thereafter, the organic solvent was removed, and compression was performed at a pressure of 1 t/cm² to form a positive electrode. In preparation of the battery, the size of the positive electrode was set to a diameter of 14 mm.

On the other hand, a negative electrode 2 includes a current collector of negative electrode 2a and a Sn layer 2b obtained by forming a layer of tin on the surface thereof. The current collector of negative electrode 2a is an aluminum foil. The amount per unit area of the Sn layer 2b is 1.5 μm in terms of thickness, and the negative electrode capacity (per geometric area of electrode) is 0.935 mAh/cm². The Sn layer 2b is formed by, for example, plating, a gas phase method or the like. Areas involved in the amounts per unit area in the positive electrode active material 1b and the Sn layer 2b are the same.

The negative electrode 2 was prepared in accordance with the following method.

As the current collector of negative electrode 2a, a current collector made of an Al foil (Al current collector) with a diameter of 15 mm and a thickness of 20 μm was used, and a soft etching treatment was first performed to remove an oxide film of the Al current collector with an alkaline etching treatment solution as a pretreatment of the Al current collector.

Next, a desmutting treatment (removal of smut (dissolution residues)) was performed using nitric acid.

After washing with water, the surface of the current collector, from which the oxide film had been removed, was subjected to a zincate treatment (zinc substitution plating) using a zincate treatment solution to form a Zn film. Here, a Zn film peeling treatment may be performed once, followed by performing a zincate treatment again. In this case, a denser thin Zn film can be formed, so that adhesion to the current collector can be improved to suppress elution of Zn.

Next, the current collector provided with a Zn film was immersed in a plating bath containing a plating solution to perform Sn plating, thereby forming the Sn layer 2b.

On the other hand, the negative electrode 2 includes the current collector of negative electrode 2a and the Sn layer 2b obtained by forming a layer of tin on the surface thereof. The current collector of negative electrode 2a is an aluminum foil. The amount per unit area of the Sn layer 2b is 1.5 μm in terms of thickness, and the negative electrode capacity (per geometric area of electrode) is 0.935 mAh/cm². The Sn layer 2b is formed by, for example, plating, a gas phase method or the like. Areas involved in the amounts per unit area in the positive electrode active material 1b and the Sn layer 2b are the same.

A separator 3 interposed between the positive electrode 1 and the negative electrode 2 is obtained by impregnating a nonwoven fabric of glass (thickness: 200 μm) with a molten salt as an electrolyte. The molten salt is a mixture of 56 mol % of NaFSA and 44 mol % of KFSA, and at a temperature equal to or higher than the melting point, the molten salt is melted to contact the positive electrode 1 and the negative electrode 2 in the form of an electrolytic solution with ions dissolved therein at a high concentration. The operating temperature range of the molten salt battery is from 57° C. to 190° C.

The composition of the molten salt is not limited to that described above, and NaFSA may be in a composition range of from 40 to 60 mol %.

In the example described above, a value obtained by dividing the positive electrode capacity by the negative electrode capacity (positive electrode capacity/negative electrode capacity) is (1.125/0.935)=1.2 provided that the areas involved in the capacity are the same as described above. This value may be from 1.0 to 1.8 inclusive from the experimental or empirical viewpoint, but is preferably from 1.1 to 1.5 inclusive as an actual product.

The coin-type molten salt battery described above is used with its internal temperature within a temperature range of from 98° C. to 190° C. out of the operating temperature range of from 57° C. to 190° C. In other words, the coin-type molten salt battery is not used at a temperature of 57° C. or higher and lower than 98° C. It has become apparent that in this case, micronization of the Sn—Na alloy in the Sn layer 2b is suppressed, so that the cycle life is increased.

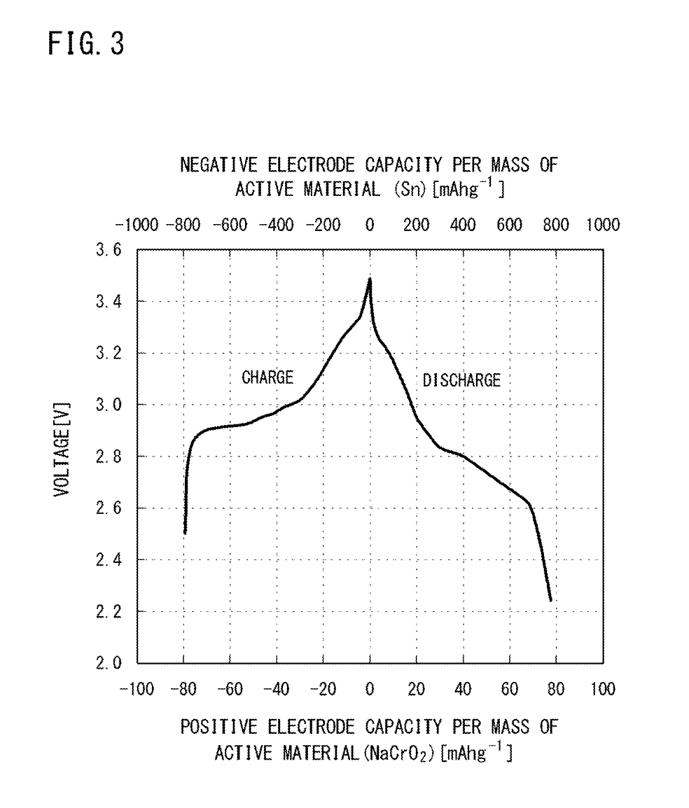

FIG. 3 is a graph illustrating charge-discharge characteristics after at least 120 cycles on the premise that the ratio of the positive electrode capacity to the negative electrode capacity is set to a value in the above-described range (from 1.0 to 1.8 (preferably from 1.1 to 1.5)) and when the use temperature of the molten salt battery is within a range of 98° C. to 190° C. Thus, it is apparent that charge-discharge is performed without reducing the capacity even after 120 cycles.

As described in detail above, according to the method for operating a molten salt battery as described above, the molten salt battery is operated with the operating temperature limited to from 98° C. to 190° C. out of the range of from 57° C. to 190° C. which is the operating temperature range of the molten salt battery. Na has a melting point of 98° C., and therefore turns to a liquid phase to suppress or correct micronization of a Sn—Na alloy. In this way, separation of the Sn—Na alloy in the negative electrode of the molten salt battery can be suppressed to improve the cycle life.

Embodiments that are disclosed herein should be considered illustrative, rather than limiting, in all respects. The scope of the present invention is defined by the appended claims, and all changes are intended to be included within descriptions and scopes equivalent to the appended claims.

### REFERENCE SIGNS LIST

1: Positive Electrode
2: Negative Electrode
10: Molten Salt Battery

1. A method for operating a molten salt battery having a sodium compound in a positive electrode and tin or a tin-containing alloy in a negative electrode with a molten salt as an electrolytic solution, the method comprising:
operating the molten salt battery with an internal temperature thereof set at from 98° C. to 190° C.

2. The method for operating a molten salt battery according to claim 1, wherein where current capacities of the positive electrode and the negative electrode are a positive electrode capacity and a negative electrode capacity, respectively, a value obtained by dividing the positive electrode capacity by the negative electrode capacity is within a range of from 1.0 to 1.8.

3. The method for operating a molten salt battery according to claim 1, wherein a content of sodium in the negative electrode at completion of charge is 3.75 times or more a content of tin contained in the negative electrode in terms of atomic ratio.

4. A molten salt battery comprising a sodium compound in a positive electrode and tin or a tin-containing alloy in a negative electrode with a molten salt as an electrolytic solution, wherein
a value obtained by dividing a positive electrode capacity by a negative electrode capacity is from 1.0 to 1.8 inclusive.

5. The molten salt battery according to claim 4, wherein a content of sodium in the negative electrode is 3.75 times or more a number of atoms of tin contained in the negative electrode in terms of atomic ratio.

6. The molten salt battery according to claim 4, wherein the negative electrode comprises an Al current collector, a zinc film provided on a surface of the Al current collector, and a tin layer provided on the zinc film.

7. The molten salt battery according to claim 4, wherein the electrolytic solution is a mixture of KFSA and NaFSA.

8. The method for operating a molten salt battery according to claim 2, wherein a content of sodium in the negative electrode at completion of charge is 3.75 times or more a content of tin contained in the negative electrode in terms of atomic ratio.
